(19) United States
(12) Patent Application Publication
(10) Pub. No.: US 2003/0170568 A1
(43) Pub. Date: Sep. 11, 2003

(54) UV curable powder suitable for use as a photoresist

(76) Inventors: Tosko A. Misev, Naperville, IL (US); Svetlana A. Bratslavsky, Elgin, IL (US); Robert Van De Berg Jeths, Apeldoorn (NL); Paul H. Binda, Zwolle (NL); Steven R. Schmid, Long Grove, IL (US)

Correspondence Address: Pillsbury Winthrop LLP, Intellectual Property Group, P.O. Box 10500, McLean, VA, 22102, US

(21) Appl. No.: 10/283,362

(22) Filed: Oct. 30, 2002

Related U.S. Application Data
(60) Provisional application No. 60/330,806, filed on Oct. 31, 2001.
(60) Provisional application No. 60/355,794, filed on Feb. 12, 2002.

(51) Int. Cl. G03C 1/725

(52) U.S. Cl. 430/281.1; 430/288.1; 430/313

(57) ABSTRACT

The invention relates to a radiation curable powder photoresist composition comprising the components A a polymer, B a reactive compound having unsaturated groups and C a free radical photoinitiator, wherein the powder photoresist composition is soluble in a developer and wherein the powder photoresist composition has a Tg between 40 and 120° C.

### CROSS-REFERENCE TO RELATED APPLICATIONS

The present application claims the benefit of U.S. provisional application No. 60/330,806 (filed Oct. 31, 2001) and No. 60/355,794 (filed Feb. 12, 2002). Both provisional applications are hereby incorporated in their entirety by reference.

### TECHNICAL FIELD OF THE INVENTION

The invention relates to a UV curable powder composition suitable as for example a photoresist composition (or photoresist), photodielectric or photo-definable buried passive material, to a method of application of the powder composition to a substrate and to substrates having a layer of UV-cured powder composition like for examples printed circuit boards. More particularly, this invention relates to a UV curable powder suitable for use as an image photoresist that may comprise high Tg polymeric binders, a reactive component or mixture of reactive components having unsaturated groups and photoinitiators. The powder may be applied to a substrate by an electromagnetic brush. The new UV curable powder applied by electromagnetic brush is particularly useful as a photoresist for the manufacture of printed circuits.

### BACKGROUND OF THE INVENTION

Printed circuit boards (PCBs) are prepared in the state of the art using photo-imaging technology. Panel plating also referred to as tent and etch, is a preferred method of preparing PCBs and contains a number of consequent steps: a photoresist composition is applied to a substrate, for example a flexible or rigid substrate comprising a copper surface; the board is exposed to actinic radiation through a mask (e.g. a film with a negative image pattern) or to a laser beam for direct imaging to selectively react (for example crosslink) the photoresist composition which makes up the desired circuit pattern; the exposed board is developed by (for example) spraying with a water-alkaline solution to remove the unreacted photoresist composition; the copper which is no longer covered by photoresist composition is etched from the substrate by means of cupric chloride or ammonium chloride and at last preferably the reacted photoresist composition is stripped from the remaining copper to provide the printed circuit board.

In an alternative method for forming PCBs, a process known as pattern plating is useful. Here a photoresist composition is applied to a substrate, like for example a flexible or rigid substrate comprising a copper surface; the board is exposed to actinic radiation through a mask (e.g. a film with a positive image pattern) or to a laser beam for direct imaging to selectively react (for example crosslink) the photoresist composition comprising substrate surface; the exposed board is developed by (for example) spraying with a water-alkaline solution to remove the unreacted photoresist composition followed by selectively exposing the underlying copper plating; copper onto the exposed copper surface preferably building copper to the top most surface of the resist plating; a tin layer onto the plated copper; stripping the reacted photoresist composition from the PCB surface exposing all copper that is not covered by the tin cover layer; etching the exposed copper by means of cupric chloride or ammonium chloride; and lastly removing the tin layer with a selective etchant.

In a further useful application of photo-imaging technology, photoresist type materials are useful as photodielectric layers as useful layers in building additional layers of circuitry in a multi layer PCB, or as useful layers in forming capacitive planes for forming thin film capacitors. Initially a photodielectric material is applied to a circuit pattern effectively covering all the circuit traces and pads. The dielectric layer is exposed through a positive image mask, where the image consists of dots positioned corresponding to required electrical though connections in the photodielectric. Exposure and development, by (for example) spraying with a water-alkaline solution to remove the unreacted photoresist composition, forms vias to the underlying circuit patterns. Circuits can be placed in the vias and on the surface of the dielectric following the tent and etch process or the pattern plating process listed above. In addition, the photodielectric approach can be repeated creating a multi layer stack of interconnected circuits.

One of the most critical steps in the production of the PCBs using photo-imaging technology is obtaining circuits with high resolution, i.e. sharp images with 2 to 3 mil lines and spaces. Presently, the most commonly used photoresists are dry film photoresists and liquid UV curable materials.

Dry film photoresists currently comprise the dominant share of primary image resists used worldwide in the manufacture of printed circuit boards. Some excellent reviews of the technology and market data associated with photoresists are contained in Imaging 2000™, published by The Quantum Performance Group, LLC in January 2001 and Printed Circuits Handbook, Fourth Edition, edited by Clyde Coombs, Jr.

A conventionally used dry film photoresist contains a carrier film layer (usually made from a polyester film), a photopolymerizable composition and a protective polyethylene cover film. This dry film photoresist is prepared by applying the photopolymerizable composition in the presence of a solvent to the carrier film. After evaporation of the solvent, the protective polyethylene cover film is used to seal the photopolymerizable composition. The carrier and cover films must be uniformly flat and even in thickness. The cover film must be free of gel particles and other physical defects that can affect the film.

Application and processing of the dry film photoresist take place by stripping off the polyethylene cover film of the photopolymerizable composition, followed by lamination to a substrate like for example copper clad laminates. The carrier sheet remains on the resist through photoexposure and is removed prior to developing the resist.

These dry film photoresists have a number of drawbacks. The carrier sheet must be optically clear and transparent to the actinic radiation applied through the phototool, and also clear and transparent to the laser for direct imaging. Use of these photoresists creates a substantial waste of polyethylene and polyester films. A limitation exists in obtaining thin layers between the carrier and protective films, which sets limitations on the resolution of the PCB to be obtained. The polyester protective film causes light scattering, which also decreases the sharpness of the image and resolution. Moreover the adhesion of the photopolymerizable composition to the copper surface is sub-optimal.

The application and processing of liquid photoresists takes place by dip, spray, roller coat, electrophoretic or curtain coat deposition of the liquid composition on a copper surface, followed by UV exposure, removal of the unexposed liquid photoresist by an alkaline solution and etching of the unprotected copper surface. One of the disadvantages of a liquid photoresist is the difficulty in obtaining reproducible and consistent thin layers by existing techniques. Another disadvantage is the required use of very expensive application equipment.

The use of liquid photoresist also has a number of disadvantages: the liquid photoresists usually contain volatile organic solvents or diluents that need to be evaporated to form a dry (tack-free) coating on the board. Many disadvantages can be envisioned with this process, like for example the need to employ expensive recovery systems, acquire environmental permitting, and secure proper protection from fire hazards. After the solvent evaporation a thin layer of unprotected photoresist is formed. It may still contain traces of solvents and is easily damaged by stacking, transport systems and handling between processing steps.

If the coating composition contains no volatile solvent or diluents, as in the case of compositions containing liquid photopolymerizable diluents, the disadvantages of the use of volatile solvents or diluents are, to a large extent, overcome. However, in this latter case, the photopolymerizable liquid diluents have the disadvantage that it is virtually impossible to obtain a dry (tack-free) coating. A dry or tack-free coating is most desirable since it makes possible the use of an appropriate patterned mask (commonly a photographic negative) in contact with the layer of photopolymerizable material, thereby making it possible to obtain high resolution and definition, a matter of increasing importance with increasing miniaturization and complexity of printed circuits.

U.S. Pat. No. 4,894,317 discloses a third method of forming a printed circuit. This method comprises coating a powder composition on a copper foil plated insulative plate. The powder composition consists of a reactive polymer having 0.5 to 5 polymerizable unsaturated groups per 1000 of number average molecular weight. The powder coating can be applied by a fluidized bed technique, an electrostatic method, an electrophoretic deposition method, or a spray coating. The powder coating composition is heat fused on the isolative plate and then cured by UV light “through a circuit pattern mask, preferably while it is in the fused liquid state to obtain a resist film.” Cure of a photoresist in the liquid state through a photomask without protective coatings means that non-contact printing should be used, which will result in lower resolution than contact printing. Furthermore it is very difficult to develop these powder compositions, using water-alkaline solutions. Such formulations require extended development times. Longer development times often lead to degradation of the cured part of the resist.

Furthermore disadvantages of these methods of application of the powder to the copper containing plate are the relatively low speed of the powder application and the limitation in the minimum film thickness and film thickness uniformity that can be obtained

### OBJECT OF THE INVENTION

It is an object of the present invention to provide a UV curable powder suitable for use as an image photoresist in an imaging process.

Another object of the invention is to obtain powder that remains stable during storage. A further object is to obtain a powder photoresist that does not stick to the photomask or phototool during the photoimaging process.

It is an object of the present invention to provide a UV curable powder composition which can be used as a photoresist in solid state and which has a non-sticky dry surface that allows intimate contact with a photomask without a need for a protective layer.

It is also an object of the present invention to provide a photoresist that allows the preparation of a printed circuit board having a very high resolution.

Another object is to provide photoresists that reduce the amount of waste materials in the process of making PCBs.

Still another object is to provide an improved method for applying the photoresist onto a substrate. This method may be used in a very efficient way, using high speed and being operated in a continuous manner, while yielding a high quality and uniform thin layer of photoresist on the copper surface.

Another object of the invention is to provide a method that allows application of thin films of photoresist on a substrate in a reproducible and consistent manner.

Another object is to provide a process for applying a powder on a substrate that offers the possibility of treating large surface areas simultaneously, without size limitation to improve the efficiency for printed circuit fabricators.

### BRIEF DESCRIPTION OF THE DRAWINGS

FIG. 1 represents a machine having the capability of electromagnetic brush coating.

### DETAILED DESCRIPTION OF THE INVENTION

The present invention relates to a radiation curable powder photoresist composition comprising the components

A a polymer,

B a reactive compound having unsaturated groups

C a free radical photoinitiator

wherein the powder photoresist composition is soluble in a developer and wherein the powder photoresist composition has a Tg between 40 and 120° C.

A different embodiment of the present invention is a radiation curable powder photoresist composition comprising the components

A a polymer, having a Tg of at least 70° C. and having a functional group that enables the polymer to be soluble in a water alkaline developer solution

B a reactive compound having unsaturated groups

C a free radical photoinitiator

wherein the powder photoresist composition has at least one of the following properties

I an acid value between 90 and 135 mg KOH/g

II a Tg between 40 and 120° C. or

III a ratio of components A and B between 2.5 and 3.3

It is preferred that component A is able to be developed or dissolved by a suitable developer, when the powder compositions has not been irradiated with UV radiation. Non limiting examples of suitable developers are a water-alkaline solution, supercritical carbondioxide or an organic solvent.

A particularly preferred class of polymeric binders A is one which is developable using an aqueous alkaline solution (thereby making it possible to wholly avoid the use of organic solvents in the process of the invention).

In principle, the instant invention is not limited to the use of any particular polymeric binder. Examples of suitable polymeric binders are thermoplastics materials based on polyacrylates, styrene-acrylic polymers, cellulose-acetate butyrate (propionate) derivatives, polyvinyl alcohol or polyvinylpyrrolidone. Component A may also comprise a thermoset polymer. Preferably component A comprises a mixture of polymers. Specific combinations of polymers with a range of number average molecular weights (MW) are desirable in order to improve the development process. Formulations with high MW polymers are more stable in etching solution and may have higher acid numbers and still withstand etching. Preferably the MW of the polymers does not exceed 60,000, in order to avoid too high viscosity after softening and less favourable conditions to prepare the powder composition by for example extrusion. Preferably the MW of the polymeric binders is higher than 1000, more preferably higher than 3000.

The preferred chemical composition of component A may change depending on the specific developer used. Where the developer is a water-alkaline solution, the following preferred embodiments may be described. Component A may contain vinyl addition polymers containing free carboxylic acid groups, which are preferably prepared from styrene or one or more alkyl acrylates and of one or more α,β-ethylenically unsaturated carboxylic acids. Suitable alkyl acrylates for use in preparing these polymeric binders include methyl acrylate, ethyl acrylate, propyl acrylate, butyl acrylate, methyl methacrylate, ethyl methacrylate and butyl methacrylate. Suitable α,β-ethylenically unsaturated carboxylic acids include acrylic acid, methacrylic acid, crotonic acid and maleic acid or anhydride. Specific examples of a polymer compound present in component A are a copolymer of vinyl acetate and crotonic acid, a terpolymer of ethyl acrylate, methyl methacrylate and acrylic acid, or cellulose acetate succinate, as well as toluene sulfonamide-formaldehyde resin, a copolymer of methyl methacrylate and methacrylic acid, a copolymer of methyl methacrylate, ethyl acrylate and methacryloxyethyl hydrogen maleate, a terpolymer of vinyl chloride, vinyl acetate and maleic acid, a copolymer of styrene and maleic anhydride or a terpolymer of methyl methacrylate, ethyl acrylate and methacrylic acid. Further specific compounds that may be used in the present invention are multi-component binders containing a combination of three or four different molecular weight polymers chosen from styrenated acrylic polymers (for example Joncryl-671, -690, and -694 from S. C. Johnson Polymer and Carboset GA-1160, -1161, -1162, and -2299 from B. F. Goodrich), acrylic resins (for example Carboset GA-526 from B. F. Goodrich and Elvacite-2669, 2965, 2900, 4004 and 2776 from Ineos Acrylics), Cellulose Acetate Propionate CAP-UV-100 from Eastman Chemical Company, and the reaction product of an epoxy cresol novolak resin (like for example Quatrex 3710) with acrylic acid.

Preferably the component A does not contain large amounts of polymeric binders having an acid number below about 75 mg KOH/g when a water-alkaline developer is used. Preferably the amount of polymeric binder having an acid number of about 75 mg KOH/g or lower does not exceed 10% by weight relative to the total composition in order to secure optimal development.

Preferably the polymers contain carboxyl and/or hydroxyl functionality and have a high Tg in the range of 70-130° C. and an acid number from 80 to 240 mg KOH/g to afford good development by water-alkaline solution.

The amount of component A preferably ranges from about 55 to 85% by weight relative to the total composition. More preferably, the amount of component A ranges from 60 to 70% by weight, relative to the total composition.

An other embodiment of the instant invention is a composition which is used in combination with supercritical carbondioxide as developer. In that case the molecular weight of the polymers that may be used as compound A may range from 1,000 to 100,000, preferably between about 3,000 and about 60,000. The Tg of component A is preferably in the range from 70-130° C. The acid number of component A may preferably range from about 0 to about 50 mg KOH/g, more preferably between 0-30 mg KOH/g, when supercritical CO₂ is used as developer.

Additional examples of polymers suitable to be used as component A in combination with supercritical CO₂ as developer include vinyl or acrylic polymer; polyester; polyether; unsaturated polyester prepared by the use of an unsaturated polybasic acid;; polyurethane; melamine resin; oil-modified alkyd resin and oil-modified aminoalkyd resin; and silicone-modified resin; polyacrylate and α-alkyl polyacrylate esters, e.g., polymethyl methacrylate and polyethyl, polyvinyl esters, e.g., polyvinyl acetate, polyvinyl acetate/acrylate, polyvinyl acetate/methacrylate and hydrolyzed polyvinyl acetate; ethylene/vinyl acetate copolymers; polystyrene polymers and copolymers, e.g., with maleic anhydride and esters; vinylidene chloride copolymers, e.g., vinylidene chloride/acrylonitrile; vinylidene chloride/methacrylate and vinylidene chloride/vinyl acetate copolymers; polyvinyl chloride and copolymers, e.g., polyvinyl chloride/acetate; saturated and unsaturated polyurethanes; synthetic rubbers, e.g., butadiene/acrylonitrile, acrylonitrile/butadiene/styrene, methacrylate/acrylonitrile/butadiene/styrene copolymers, 2-chlorobutadiene-1,3 polymers, chlorinated rubber, and styrene/butadiene/styrene, styrene/isoprene/styrene block copolymers; high molecular weight polyethylene oxides of polyglycols having number average molecular weights form about 4,000 to 1,000,000; epoxides, e.g., epoxides containing acrylate or methacrylate groups; copolyesters, e.g., those prepared from the reaction product of a polymethylene glycol of the formula HO(CH₂)ₙOH, where n is a whole number 2 to 10 inclusive, and (1) hexahydroterephthalic, sebacic and terepthalic acids, (2) terephthalic, isophthalic and sebacic acids, (3) terephthalic and sebacic acids, (4) terephthalic and isophthalic acids, and (5) mixtures of copolyesters prepared from said glycols and (i) terephthalic, isophtalic and sebacic acids and (ii) terephthalic, isophthalic, sebacic and adipic acids; nylons or polyamides, e.g., N-methoxymethyl polyhexamethylene adipamide; cellulose esters, e.g., cellulose acetate, cellulose acetate succinate and cellulose acetate butyrate; cellulose ethers, e.g., methyl cellulose, ethyl cellulose and benzyl cellulose; polycarbonates; polyvinyl acetal, e.g., polyvinyl butyral, polyvinyl formal; polyformaldehydes.

Component B contains at least one reactive compound having one or more unsaturated groups. The one or more reactive compounds preferably are monomeric or oligomeric compounds. Examples of unsaturated groups are acrylate and methacrylate groups. Preferably, the unsaturated groups are acrylate groups.

Examples of reactive compounds are monomers or oligomers having 1 to 6 acrylic functional groups or compounds like styrene. Suitable unsaturated monomeric compounds which can optionally be used in combination with other monomers include: t-butyl acrylate and methacrylate, 1,5-pentanediol diacrylate and dimethacrylate, N,N-diethylaminoethyl acrylate and methacrylate, ethylene glycol diacrylate and dimethacrylate, 1,4-butanediol diacrylate and dimethacrylate, diethylene glycol diacrylate and dimethacrylate, 1,3-propanediol diacrylate and dimethacrylate, decamethylene glycol diacryalte and dimethacrylate, 1,4-cyclohexanediol diacrylate and dimethacrylate, 2,2-dimethylopropane diacrylate and dimethacrylate, glycerol diacrylate and dimethacrylate, tripropylene glycol diacrylate and dimethacrylate, glycerol triacrylate and trimethacrylate, trimethylolpropane triacrylate (“TMPTA”) and trimethacrylate, pentaerythritol triacrylate and trimethacrylate, polyoxyethylated trimethylolpropane triacrylate (e.g. ethoxylated9 TMPTA; SR-502) and trimethacrylate, 2,2-di(p-hydroxyphenyl)-propane dimethacrylate, triethylene glycol diacrylate, polyoxyethyl-2,2-di-(p-hydroxyphenyl)-propane dimethacrylate, di-(3-methacryloxy-2-hydroxypropyl) ether of bisphenol-A, di-(2-methacryloxyethyl) ether of bisphenol-A, di-(3-acryloxy-2-hydroxypropyl) ether of bisphenol-A, di(2-acryloxyethyl) ether of bisphenol-A, di-(3-methacryloxy-2-hydroxypropyl) ether of tetrachloro-bisphenol-A, di-(2-methacryloxyethyl) ether of tetrachloro-bisphenol-A, di-(3-methacryloxy-2-hydroxypropyl) ether of tetrabromo-bisphenol-A, di-(2-methacryloxyethyl) ether of tetrabromo-bisphenol-A, di-(3-methacryloxy-2-hydroxypropyl) ether of 1,4-butanediol, triethylene glycol dimethacrylate, polyoxypropyltrimethylol propane triacrylate, butylene glycol diacrylate and dimethacrylate, 1,2,4-butanetriol triacrylate and trimethacrylate, 2,2,4-trimethyl-1,3-pentanediol diacrylate and dimethacrylate, 1-phenyl ethylene-1,2-dimethacrylate, diallyl fumarate, styrene, 1,4-benzenediol dimethacrylate, 1,4-diisopropenyl benzene, and 1,3,5-triisopropenyl benzene).

Other examples of multifunctional acrylate compounds are aliphatic polyfunctional (meth)acrylates like, for example, the triacrylates and trimethacrylates of hexane-2,4,6-triol, glycerol, or 1,1,1-trimethylolpropane, ethoxylated or propoxylated glycerol, or 1,1,1-trimethylolpropane and hydroxy group-containing tri(meth)acrylates which can be obtained by the reaction of triepoxy compounds, such as, for example, the triglycidyl ethers of the mentioned triols, with (meth)acrylic acid.

It is also possible to use hexafunctional urethane (meth)acrylates. Those urethane (meth)acrylates are known to the person skilled in the art and can be prepared in known manner, for example by reacting a hydroxy-terminated polyurethane with acrylic acid or methacrylic acid, or by reacting an isocyanate-terminated prepolymer with hydroxyalkyl (meth)acrylates to follow the urethane (meth)acrylate. Also low viscosity oligomers like ethoxylated2 bisphenol A dimethacrylate (SR-348) and ethoxylated3 bisphenol A diacrylate (SR-349) can be used as a part of the component B. Low viscosity oligomers, preferably multifunctional, as supplied by Cognis, can be used as a part of component B. Examples of such low viscosity oligomers are Photomer 6173, 5018, 6019, 4028, RCC 13-429, RCC 13-430, RCC 13-432 and RCC 12-891. The most preferred of these are Photomer 5018 and RCC 13-429.

More preferable, component B comprises 2-4 functional monomers. Examples of preferred 2-4 functional acrylic monomers are for example liquid monomers, like for example trimethylolpropane triacrylate (SR-351), pentaerythritol tetraacrylate (SR-295), bistrimethylolpropane tetra-acrylate, pentaerythritol monohydroxytri(meth)acrylate and dipentaerythritolpentaacrylate (SR 399) or solid monomers, like for example tris (2-hydroxy ethyl) isocyanurate triacrylate (SR-368), cyclohexane dimethanol diacrylate (CD406) and cyclohexane dimethanol dimethacrylate (CD401).

Preferably component B is a mixture of at least two reactive compounds. The mixture is preferably a combination of liquid and solid reactive compounds at a temperature of 20° C. in order to provide a powder photoresist with the ability to cure at room temperature, to be developed by a water alkaline solution with a high resolution and to maintain a sufficient powder stability. More preferably component B contains a liquid component at 20° C. and a solid or waxy component having a melting point of at least 35° C., preferably at least 45° C.

Preferably the amount of component B ranges between about 15 and about 45% by weight of the total composition. More preferably, the amount ranges between about 20 and about 27% by weight.

More preferably the component B contains between 12 and 22% by weight relative to the total composition of reactive liquid monomers in order to obtain sufficient cure at room temperature and to achieve the preferred final properties of the photoresist. Such a resist may have the right balance between the ability of the cured photoresist to withstand the developing and etching process and the ability of the uncured photoresist to develop efficiently. Moreover the powder will have a sufficient storage stability.

Most preferably, the component B contains between 15 and 20% by weight of a liquid reactive compound and between about 3 and 8% by weight of at least one solid or waxy reactive compound having a melting point higher than 35° C., preferably higher than 45° C.

Component C is a photoinitiator that forms active radicals upon irradiation with light. In principle any photoinitiator may be used in the present invention. Preferably, the photoinitiator is sufficiently stable at elevated temperatures, to allow for the mixing of components A, B and C in an extrusion step. Preferably the photoinitiators used in the compositions are those active under actinic light and thermally inactive at 185° C. or below. Examples of suitable photoinitiators include 2-ethylanthraquinone, phenanthraquinone; 2,4,5-triarylimidazole dimers such as 2-(o-chlorophenyl)-4,5-diphenylimidazole dimer, 2-(o-chlorophenyl)-4,5-di(m-methoxyphenyl) imidazole dimer, 2-(o-fluorophenyl)-4,5-diphenylimidazole dimer, 2-(p-methoxyphenyl)-4,5-diphenylimidazole dimer, 2,4-di(p-methoxyphenyl)-5-phenylimidazole dimer, 2-(2,4-dimethoxyphenyl)-4,5-diphenylimidazole dimer, 2-(p-methylmercaptophenyl)-4,5-diphenylimidazole dimmer; vicinal ketaldonyl compounds, such as for example, diacetyl and benzil; alpha-ketaldonyl alcohols, such as for example benzoin and pivaloin; acyloin ethers, e.g., benzoin methyl and ethyl ethers; alpha-hydrocarbon substituted aromatic acyloins; unsubstituted polynuclear quinones, such as, 9,10-anthraquinone; 1-chloroanthraquinone, 2-chloroanthraquinone, 2-methylanthraquinone; 2-ethylanthraquinone; 2-tert-butylanthraquinone; octamethylanthraquinone; 1,4-naphthaquinone; 9,10-phenanthraquinone; 1,2-benzanthraquinone; 2,3-benzanthraquinone; 2-methyl-1,4-naphthaquinone; 2,3-dichloronaphthaquinone; 1,4-dimethylanthraquinone; 2,3-dimethylanthraquinone; 2-phenylanthraquinone; 2,3-diphenylanthraquinone; sodium salt of anthraquinone alpha-sulfonic acid; 3-chloro-2-methylanthraquinone; 7,8,9,-10-tetrahydronaphthacenequinone; 1,2,3,4-tetrahydrobenz(a) anthracene-7,12-dione.

Preferably free radical photoinitiators may be chosen in such a way that they cover the entire emission spectra of the UV lamp. It is most preferable to use a combination of photoinitiators, including those suggested by Ciba for photoresists, colored coatings, inks and for powder coatings like for example Irgacure 907 with ITX(isopropyl thioxanthone)-triplet sensitizer, Irgacure 819, Irgacure 2959 and Irgacure 184. Preferably, solid photoinitiators that do not decrease the Tg of the final powder photoresist formulation may be used.

Preferably the amount of photoinitiators is between about 0.1 and about 15% by weight. More preferably, the amount of photoinitiators is between about 3 and about 8% by weight, relative to the total composition.

Additives

In addition to components A, B and C also additives may be added to the composition. Examples of additives include colorants like for example dyes and pigments, thermal polymerization inhibitors, antioxidants, plastisizers, adhesion promoters and flow agents. Suitable colorants will preferably be compatible with the photosensitive compositions and not interfere appreciably with the photosensitivity of the composition. The following specific compounds are illustrative examples of such colorants: Fuchsine (C. I. 42510); Auramine Base (C. I. 4100B); Calcocid Green S (C. I. 44090); Para Magenta (C. I. 42500); Tryparosan (C. I. 42505); New Magenta (C. I. 42520); Acid Violet RRH (C. I. 42525); Red Violet 5RS (C. I. 42690); Nile Blue 2B (C. I. 51185); New Methylene Blue GG (C. I. 51195); C. I. 51195); C. I. Basic Blue 20 (C. I. 42585); Iodone Green (C. I. 42556); Night Green B (C. I. 42115); C. I. Direct Yellow 9 (C. I. 19540); C. I. Acid Yellow 17 (C. I. 18965); C. I. Acid Yellow 29 (C. I. 18900); Tartrazine (C. I. 19140); Supramine Yellow G (C. I. 19300); Buffalo Black 10B (C. I. 27790); Napthalene Black 12R (C. I. 20350); Fast Black L (C. I. 51215); Ethyl Violet (C. I. 42600); Pontacyl Wood Blue BL (C. I. 50315); Pontacyl Wood Blue GL (C. I. 52320). (Numbers were obtained from the second edition of Color Index.) Dyes that are solid at room temperature are preferred.

Thermal polymerization inhibitors may also be present in the preferred compositions. Examples of inhibitors include compounds like p-methoxyphenol, hydroquinone, alkyl and aryl-substituted hydroquinones, quinines, tert-butyl catechol, pyrogallol, copper resinate, naphthylamines, betanaphtol, cuprous chloride, 2,6-di-tert-butyl p-cresol, 2,2-methylenebis-(4-ethyl-6-t-butylphenol), phenothiazine, pyridine, nitrobenzene, dinitrobenzene, chloranil, aryl phosphates, and aryl alkyl phosphates.

Solid inhibitors are preferred. All additives can be used in ranges recommended in the literature for powder coatings, dry film photoresists or by the additive's producers.

Adhesion promoters may be used to enhance adhesion of the photoresist to the metal. An example of a very suitable adhesion promoter is benzotriazole. This adhesion promotor may be used in an amount from 0.001 to 1% by weight, preferably between 0.1 and 0.4% by weight.

Flow agents may be used in the composition of the invention. Examples of flow agents include, BYK-361, BYK-356, and BYK-359. They can be used in amounts between about 0.001 and about 1% by weight. Various grades of Modaflow or other similar flow agent types can also be employed.

Antioxidants may also be preferably used. Examples of antioxidants include triphenylphosphine, triphenylphosphite, Irganox 1010 and Irganox 1035.

Fillers may also be added to the compositions. Examples of such fillers are mica, alumina, gypsum, talk, TiO₂, chalk, powdered quartz, cellulose, kaolin, ground dolomite, wollastonite, diatomaceous earth, silica (like for example a fumed silica like Aerosil, Art Sorb, Baykisol, Bindzil, Biogenic silica, Britesorb, Cab-O-Sil, Celatom, Celite, Clarcel, Colloidal silica, Decalite, Diamantgel), Barium Titanates, hollow glass or ceramic spheres, alumina modified with amines having a long chain length, bentones, powdered polyvinyl chloride, polyolefins or amino plastics. Addition of silicas like aerosil or Cab-O-Sil to the powder, for example after preparation of the powder, may improve the flowability of the powder (the ability of the powder particles to move freely, fluidize) and/or the shelf life of the powder even at elevated temperatures like for example 35° C. Examples of preferred silicas for improvement of the powder are fumed silicas like aerosil from Degussa, like for example Aerosil R-202, R200 or R972, or surface treated silica, like for example Cab-O-Sil® TS 530 from Cabot Corporation.

The additives may be used in amounts from about 0.1 to about 15% by weight. Preferably the total amount of additives ranges between about 1 and about 5% by weight, relative to the total composition. The amount of aerosil that may preferably be applied after extrusion and optionally milling and sieving the composition of the present invention is preferably present in an amount between 0.01 and 5 wt % relative to the weight of the extrudate.

Composition Properties

The usefulness of photopolymerizable compositions for powder resists, which become solid films after application to a substrate preferably containing a copper surface, depends on the proper balance of several properties such as: ability to cure under UV light, developability, aabsence of tackiness, resistance to etching solution, sufficient adhesion to substrate and flexibility. These properties will be achieved when the photoresist satisfies at least one of the properties I-III. Preferably at least two properties are satisfied. More preferably all properties I-III are satisfied.

The first property is a requirement for the composition to have an acid value between about 90 and about 135 mg KOH/g, measured according to ASTM D-1639.

Formulations having high acid numbers (>135 mg KOH/g), or having components with high acid numbers (>240 mg KOH/g), are generally unstable in developing and etching solutions and are therefore less preferred.

A second preferred property of the composition is to be a solid. This may be described by the fact that the composition has a Tg between about 40 and about 120° C., measured with DMA according to the experimental part of the specification. More preferably the Tg of the composition is between 50 and 70° C.

A third preferred property of the composition is that the ratio of component A to component B preferably is between 2.5 and 3.3. This may result in the preparation of a preferred non-sticky powder that has sufficient reactivity to be cured under UV light.

Preparation of the Powder Composition

The powder composition contains several components varying in physical state and physical properties. Preferably all components are premixed and the resulting mixture may be extruded at a temperature between for example 120-170° C. in order to obtain a uniform mixing of component A with component B and C and other optional additives. Any suitable way of mixing all components may however be applied. After mixing all components, a milling and sieving step may be applied to obtain a uniform particle size distribution. An example of a suitable method for milling the extruded composition is a method of grinding with the use of a jet-mill apparatus.

Method of Applying Photoresist onto a Substrate

A preferred method of application of powder particles to a substrate is done by means of an electromagnetic brush (EMB). This method is characterized in that powder particles are first charged by friction or induction in the presence of magnetic or non-magnetic particles, are next transported and then applied to the substrate, or alternatively that powder particles are applied to a transfer medium and subsequently transferred to the substrate, by means of an electric field between the substrate, respectively the transfer medium, and the means of transport, where after the powder photoresist composition is fused and the powder photoresist adheres to the substrate.

If a transfer medium is used, the powder particles are first applied to the transfer medium by means of an electric field, transported to the substrate by the transfer medium and then applied to the substrate by, for example, electrical, electrostatic or mechanical forces.

Generally, the median particle size (by volume) of the powder photoresist particles X_{50,3} (as defined according to the description and notation at pages 12-14 of Mechanische Verfahrenstechnik by Prof. Rumpf (Carl Hansen Verlag, 1975)) can be for example below about 200 μm, and preferably, between about 5 and 60 μm.

The selection of the particle size depends on for example the desired final photoresist thickness for a given application.

The particle size distribution can be as broad as it is in conventional powder paint technology. Preferably, the particle size distribution is relatively narrow. More preferably, the ratio X_{75,3}:X_{25,3}<3 (according to the definition in the aforementioned Rumpf), since the efficiency of the EMB-development step may vary with the particle size.

Carrier particles can be either magnetic or non-magnetic. Preferably, the carrier particles are magnetic particles. It is one of the advantages of the EMB process that it is possible to apply particles having median particle sizes between about 5-30 μm. It is very difficult to apply these particles with conventional spray guns.

Suitable magnetic carrier particles have a core of, for example, iron, steel, nickel, magnetite, γ-Fe₂O₃, or certain ferrites such as for example CuZn—, NiZn—, MnZn— and Ba ferrites. These particles can be of various shapes.

Exemplary non-magnetic carrier particles include glass, non-magnetic metal, polymer and ceramic material.

Generally, the carrier particles have a median particle size between 20 and 700 μm. Preferably, the carrier particle size distribution is narrow and more preferably the ratio X_{75,3}:X_{25,3}<2.

Preferably the carrier core particles are coated or surface treated with diverse organic or inorganic materials to obtain, for example, desirable electrical, triboelectrical and/or mechanical properties. Inorganic materials are described in for example U.S. Pat. No. 4,925,762 and U.S. Pat. No. 5,039,587. Organic coating materials include, for example, polymers having fluoro-, silicone-, acrylic-, styrene-acrylic, melamine- or urethane-group. Mixtures of these polymers can also be used. Preferably a fluoro-containing polymer is used as the carrier core particle coating.

The carrier coatings can comprise suitable fillers or additives to control for example, triboelectrical, electrical or mechanical properties of the carrier coating. For example, conductive materials such as, carbon black and metal powder, or charge controlling materials and flow improving materials can be used.

The carrier particles may be conductive (as described in for example U.S. Pat. No. 4,076,857) or non-conductive.

For direct application without a transfer medium, on a metal substrate, the carrier particles should be preferably non-conductive and they should have a well-defined high resistivity of, for example, 10⁹-10¹¹ Ohm at 10V potential and a break-through voltage above 1,000V (measured with a c-meter supplied by Epping GmbH).

In case of use of a transfer medium the carrier particles also can be conductive or non-conductive.

An EMB-developer comprises powder photoresist particles and carrier particles. An EMB-development method is a way of developing and an EMB-development unit is a complete system comprising of, for example, an EMB-developer roller (transport medium), mixing screw(s), a supply device, blades, detectors and the like. Other examples are described in, for example, GB-A-2097701, U.S. Pat. No. 4,147,127 and U.S. Pat. No. 4,131,081.

In the present invention the EMB-development method can be either one-component or two-component.

Preferably, the two-component EMB-development method, in which the carrier particles are mixed with the powder photoresist particles, is used.

Preferably, a combination of powder photoresist particles having a X_{50,3} below 80 μm and a X_{95,3} below 120 μm and carrier particles having a X_{50,3} below 180 μm and a X_{95,3} below 200 μm is used.

More preferably, a combination of powder photoresist particles having a X_{50,3} below 30 μm and above 5 μm and a X_{95,3} below 50 μm and carrier particles having a X_{50,3} below 180 μm and above 5 μm and a X_{95,3} below 200 μm is used.

In the two-component EMB-developer the amount of powder photoresist particles can be, for example, between about 1 and 50 wt. % and preferably between about 5 and about 25 wt. % (relative to the amount of EMB-developer). It is an advantage of the process according to the invention that it is possible to use powder photoresist concentrations well in excess of 10 wt. %. Consequently, the amount of carrier particles can be between about 50 and about 99% by weight (relative to the amount of EMB-developer) and preferably is between about 75 wt. % and about 95 wt. %.

The powder photoresist concentration can be controlled externally or internally in the EMB-development unit. External control can be effected by measurement of layer thickness of uncured or cured powder by, for example, optical, photothermal or dielectrical means. Internal control can be carried out in the developer station by means of powder photoresist concentration control by any suitable means like inductive control (see, for example, U.S. Pat. No. 4,147,127 and U.S. Pat. No. 4,131,081) or volume control.

In a two-component EMB-development method the powder photoresist particles are preferably triboelectrically charged by intensive mixing and friction with the carrier particles.

In the process according to the present invention it is also possible to use a one component EMB-development method with the carrier particles being incorporated in the powder photoresist particles as disclosed in, for example, U.S. Pat. No. 4,803,143 and U.S. Pat. No. 4,543,312.

In a one-component EMB-development method the particles are charged by induction or friction, depending on the selection of the powder photoresist particles.

Both one- and two-component developers can be transported by magnetic, electric and/or mechanical transport.

When two-component EMB-developers are used, the parameters which are relevant for the process (such as, for example, powder photoresist concentration, EMB-development potential and machine parameters) can be chosen depending on the application. This may lead to batch EMB-developer replacement, e.g. after certain time intervals or if certain parameters are out of a control range. Preferably, continuous EMB-developer material replenishment, as described in, for example, U.S. Pat. No. 4,614,165,can be used to avoid process interruption for batch replenishment.

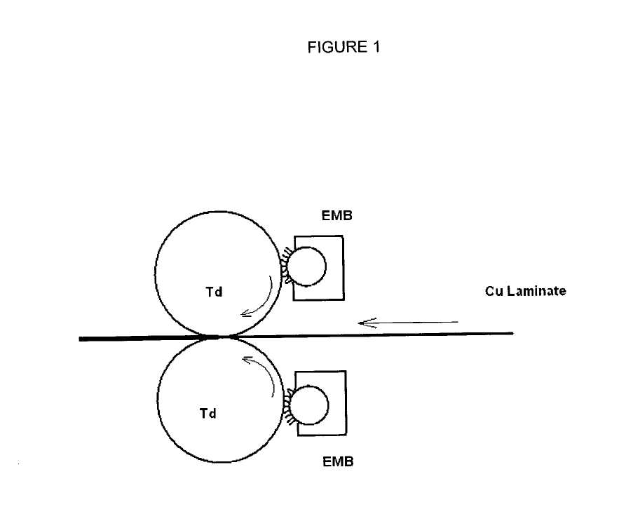

The EMB method allows to coat the substrate on either one or both sides. An example of a machine having this ability is shown in FIG. 1 (Td indicates transfer drum).

After the application of a uniform thin layer to copper clad laminate, the powder may preferably be fused under an IR lamp or in a convection oven at 150-180° C. Both processes take one to three minutes in order to get a continuous layer of photoresist. The obtained copper clad laminates covered with a UV curable photoresist may be used in an imaging process to selectively cure the photoresist through the photomask.

Photoimaging

Surprisingly the photoresists according to this invention are not sticky (tacky) even at high temperature, and can be used in contact with a photomask or phototool without damaging it. Room temperature cure is also possible, but usually requires higher doses of radiation. As it is well known to those skilled in the art, contact printing gives better resolution than the projection method. Direct contact without a protective cover sheet also brings advantages to the ultimate resolution achieved.

Since free-radical initiators generally exhibit their maximum sensitivity in the ultraviolet range, the radiation source should furnish an effective amount of this radiation. Both point or broad radiation sources are effective. Such sources include carbon arcs, mercury-vapor arcs, electrodeless, microwave stimulated lamps, fluorescent lamps with ultraviolet radiation-emitting phosphors, argon glow lamps, pulsed Xenon lamps, electronic flash units and photographic flood lamps.

Development

The photopolymerizable compositions after exposure can be developed, e.g., by impingement of spray jets, with agitated immersion brushing or scrubbing to desirable images. Developers can be, for example, water alkaline solutions, supercritical carbon dioxide or organic solvents. Preferably the developer is an aqueous base, i.e., an aqueous solution of a water-soluble base in concentrations generally in the range from 0.01 to 10 percent by weight.

Suitable bases for the development include the alkali metal hydroxides, e.g., lithium, sodium and potassium hydroxide; the base-reacting alkali metal salts of weak acids, e.g., lithium, sodium, and potassium carbonates and bicarbonates; amines having a base ionization constant greater than about 1×10⁻⁶, e.g., primary amines, such as benzyl, butyl and allyl amines; secondary amines, e.g., dimethylamine and benzyl methyl amine; tertiary amines, e.g., trimethylamine, and triethylamine; primary, secondary, and tertiary hydroxyamines, e.g., diethanol and triethanol amines, and 2-amino-2-hydroxymethyl-1,3-propanediol; cyclic amines, e.g., morpholine, piperidine, piperazine, and pyridine; polyamines, such as hydrazine, ethylene and hexamethylene amines; the water-soluble basic salts, e.g., the carbonates and bicarbonates of the above amines; ammonium hydroxide and tetra-substituted ammonium hydroxides, e.g., tetramethyl-, tetraethyl-, trimethylbenzyl-, and trimethyphenylammonium hydroxides, sulfonium hydroxides, e.g., trimethyl-, diethylmethyl-, dimethylbenzylsulfonium hydroxides, and the basic soluble salts thereof, e.g., the carbonates, bicarbonates and sulfides; alkali metal phosphates and pyrophosphates, e.g. sodium and potassium triphosphates and sodium and potassium pyrophosphates; tetra-substituted (preferably wholly alkyl) phosphonium, arsonium, and stibonium hydroxide, e.g., tetramethyl-phosphonium hydroxide.

Although all of the above could be used generally, simple 1.0% K₂CO₃ solution in water at 30° C. is proven to be reliable and a good developer, effective by simply spraying for 30-90 seconds without additional brushing.

Etching

The photopolymerized image area then serves as an excellent resist for the deep-etching processes normally encountered in the fabrication of printed circuit boards. These resists are resistant to the common etchants, e.g., ferric chloride, Baume ferric chloride and nitric acid, filling agents, and other agents commonly added to the etching mixture to control the geometry of the etch.

As most often used in industry today, solutions of copper chloride or ammonium chloride etchants demonstrated the exclusive properties of UV curable powder photoresist, made according to the present invention.

An example of an etching process is a process wherein the boards can be etched with 45° Baume ferric chloride solution at 130° F. (55° C.). The boards were left in the etching apparatus until the copper was completely etched away in the areas not covered by the resist image. The etched board was rinsed in water and dried, leaving the resist covered copper conducting pattern on the fiberglass board.

Stripping

The photopolymerized compositions can generally be removed by immersion in heated aqueous solutions of strong alkalies or, if desired, in proprietary stripping formulas well known in the art.

The final resolution of the printed circuit boards made according to the present invention is at least 100 micron, preferably better than 75 micron, more preferably better than 50 micron.

### EXAMPLES

The invention is illustrated with examples, which however do not limit the scope of the invention.

In the examples a number of polymeric binders is used as component A. Some data on the commercially available polymeric binders used in the examples are given in table 1.

TABLE 1
Properties of polymeric binders

| Components | Polymer type | MW | Tg, ° C. | Acid #, mg KOH/g |
|---|---|---|---|---|
| CarbosetGA 1160 | styrenated acrylic polymer | 7000 | 120 | 220 |
| Elvacite 2669 | acrylic resin | 60,000 | 70 | 124 |
| CAP-UV-100 | Cellulose Acetate Propionate | 18,000 | 120 | 80 |
| Carboset 1162 | styrenated acrylic polymer | 2,700 | 100 | 220 |
| Joncryl 690 | styrenated acrylic polymer | 16,500 | 102 | 240 |
| Joncryl 671 | styrenated acrylic polymer | 17,250 | 128 | 212 |
| Joncryl 694 | styrenated acrylic polymer | 13,700 | 106 | 200 |

### Example I

Preparation of a Powder Photoresist 10 kg of powder photoresist was prepared by premixing all the components presented in Table 2 by the Wt. % ratio in a “Diosna” V-30 batch mixer.

TABLE 2

| Components | Wt. % |
|---|---|
| CarbosetGA 1160 | 13.3 |
| CAP-UV-100 | 8.2 |
| Joncryl 694 | 45.2 |
| SR-368 | 4.8 |
| SR-349 | 4.5 |
| SR-295 | 15.4 |
| Irgacure 907 | 2.0 |
| ITX | 0.7 |
| Quantacure EPD | 2.2 |
| Irgacure 819 | 1.2 |
| Irgacure 2959 | 1.3 |
| Benzotriazol | 0.3 |
| BYK-356 | 0.4 |
| Victoria pure Blue BO | 0.1 |
| Irganox 1010 | 0.4 |

After mixing, the mixture was extruded on a Prizm Extruder at 168° C. at 200 RPM. A clear extrudate was obtained without visible non-homogeneous inclusions. After cooling the extrudate, the extrudate was milled first in a hammer mill to a particle size <3 mm and then fed into a fluidized bed mill (Condux CFS8), having a nozzle diameter of 4 mm. The material was milled with 5 bar air overpressure at 1900 rpm of the classifier wheel incorporated in the mill obtaining a powder photoresist with a median particle size of 24 μm and a X_{75,3}/X_{25,3} ratio of 2.3. The obtained powder photoresist has a Tg=61° C. and an acid number=127 mg KOH/g.

The Tg has been measured according to the following DMA procedure, which has been developed for measuring powders in an RSA-II instrument. In order to make an acceptable sample for DMA measurement, the powder was dissolved in acetone. The acetone solution was soaked into a rectangular piece of Kimwipe® paper, which had been previously cut to the dimensions of a standard sample. The rectangular pieces were then allowed to dry in air. These composites of sample and cellulose reinforcing fibers had sufficient strength to be mounted and measured. The samples were warmed briefly to 50° C. to allow stretching, and then quickly cooled. The quantities E′, E″, and tan delta were recorded and plotted vs. temperature, and the Tg of obtained powder was determined.

### Example II

Preparation of a Carrier

998 parts by weight Cu—Zn-ferrite powder, having a median particle size of 81 μm and a ratio X_{75,3}/X_{25,3} of 1.32 (both measured with the laser granulometer Cilas HR 850), were dry coated with two parts by weight polyvinylidenedifluoride (Kynar 301F™) by mixing both materials in a Lödige mixer and coating the polymer on the surface of the ferrite in a rotary kiln at 200° C. under Nitrogen to obtain a carrier with a median size of 80 μm, a ratio X_{75,3}/X_{25,3} of 1.32, a resistance of 1.1*10¹⁰ Ohm at a potential of 10V and a break-through voltage above 1,000V (both measured in a c-meter of Epping GmbH).

### Example III

Preparation of EMB-Developer for Flexible Cu Laminated Substrate.

20% by weight of the powder composition made according to Example 1 and 80% by weight of the carrier according to Example II were brought into the EMB-developer station OCE-2240, which is build in a prototype EMB-machine.

Total filling was 8 kg. The powder photoresist and the carrier were mixed for one minute in order to obtain an EMB-developer. The charging of the EMB-developer was measured in a Q/m of Epping GmbH, showing charge value of 15 μCoulomb/g.

### Example IV

### Application of Powder Photoresist on the Flexible Cu-Laminated Substrate

The EMB-developer station was positioned at a distance of 7.5 mm from the transfer drum of the EMB prototype. Then the flexible Cu laminated substrate useful for flexible circuit boards was mounted on the substrate drum of the EMB prototype, which was then positioned at 50 μm away from the transfer drum.

The rotation speed of both drums (substrate and transfer drum) was 30 m/min and the speed of the magnetic brush of the OCE-2240 EMB-developer station was set at 30 Hz in the opposite direction of the transfer drum.

The development potential of the electromagnetic brush roller and that of the transfer drum were set to the following values (Table 3). Two sets of development voltage are illustrative for different film thickness. After application on the copper laminate substrate, the powder photoresist was heated 2 min at 130° C. by means of an IR lamp to obtain a good flowing film with a pinhole free surface.

TABLE 3

| | Development | Average Powder Photoresist layer |
|---|---|---|
| Device | Voltage, V | thickness after melting, μm |
| EMB roller | −1250 | 20 |
| Transfer drum | −500 | |
| EMB roller | −1000 | 14 |
| Transfer drum | −500 | |

### Example V

### Application of Powder Photoresist on the Cu-Clad Laminate (Rigid Substrate)

Powder, prepared according to Example I, and Carrier, according to Example II, were used. EMB-developer was prepared according to Example III, with only difference that the weight ratio of the powder to the carrier is 15 to 85. Application of powder was performed without the use of a substrate drum. Cu laminate was brought in contact with and conveyed over the transfer drum with the same speed and direction as the rotation speed of the transfer drum (6 m/min). The development potential of the electromagnetic brush roller and that of the transfer drum were set to the values shown in Table 4. Two sets of development voltage were used to obtain different film thickness of 21 and 15 μm. After application on the copper clad laminate, the coated laminate was heated 2 min at 180° C. in a convection oven (where a peak metal temperature of 150° C. was reached) to obtain a good flowing film with a pinhole free surface.

TABLE 4

| | Development | Average Powder Photoresist layer |
|---|---|---|
| Device | Voltage, V | thickness after melting, μm |
| EMB roller | −1250 | 21 |
| Transfer drum | −500 | |
| EMB roller | −1000 | 15 |
| Transfer drum | −500 | |

### Example VI

### Obtaining an Inner Layer of a Printed Circuit Board

Cu clad laminate board with melted powder photoresist, prepared according to examples I,II,V was photoimaged after cooling the surface to room temperature using intimate contact with a negative photomask in Accuprint AP-30-imaging equipment from Olec with a 8000 W lamp. Cure dose was 1200 mJ/cm². Immediately after cure, powder photoresist was developed with 1% potassium carbonate solution in water at 30±1° C. Development speed was 140 inch/min (3.6 m/min) and time for development was only 30 sec. Etching of 0.5 oz Cu-clad laminate, using ammonium chloride etchant, was done at 120° F. (49° C.) with a speed of 80 inch/min (2 m/min) For stripping strong alkaline solution (3% NaOH at 45° C.) was used. A circuit with 2-3 mil (50.8-76.2 μm) resolution was obtained.

The same overall result was obtained when the photoresist was photoimaged at a temperature of 80° C. with a dose of 210 mJ/cm².

### Example VII

Powder formulation prepared according to Example I was applied by a Corona gun. Such method of application led to a laminate having a photoresist layer with a thickness of 30-35 μm. The development speed was lower compared to Example VI: However good development was achieved at much slower rate: at 22 inch/min (˜0.6 m/min). 3-4 mil (76.2-101.6 μm) lines and spaces were obtained. This illustrates that powder photoresist has good properties and can be applied to a laminate using different techniques. However application of the powder photoresist with the preferred method of EMB-application enhances the results: it shows better resolution and shorter time for the development process.

### Examples VIII-XVI

Formulations were prepared and applied on Cu-clad laminate in accordance with Examples I,II,III,V. Formulations are presented in a Table 5.

TABLE 5
Examples of preferred powder photoresist according to the invention

| Components | Ex. VIII | Ex. IX | Ex. X | Ex. XI | Ex. XII | Ex. XIII | Ex. XIV | Ex. XV | Ex. XVI |
|---|---|---|---|---|---|---|---|---|---|
| CarbosetGA 1160 | 33.50 | 33.45 | | 7.38 | 7.26 | 7.40 | 13.69 | 27.38 | 20.54 |
| Elvacite 2669 | 26.84 | 26.80 | 29.67 | 12.67 | 12.46 | 12.71 | 0.00 | 13.69 | 12.32 |
| CAP-UV-100 | 6.76 | 6.75 | 0.00 | 7.98 | 7.85 | 8.00 | 8.41 | 0.00 | 8.21 |
| Carboset 1162 | 0.00 | 0.00 | 25.52 | 0.00 | 0.00 | 0.00 | 0.00 | 0.00 | 0.00 |
| Joncryl 690 | 0.00 | 0.00 | 11.57 | 0.00 | 0.00 | 0.00 | 0.00 | 0.00 | 0.00 |
| Joncryl 671 | 0.00 | 0.00 | 0.00 | 39.80 | 39.16 | 39.92 | 0.00 | 27.38 | 27.38 |
| Joncryl 694 | 0.00 | 0.00 | 0.00 | 0.00 | 0.00 | 0.00 | 46.36 | 0.00 | 0.00 |
| SR-368 | 3.78 | 3.77 | 3.86 | 3.69 | 4.36 | 4.11 | 4.16 | 4.16 | 4.16 |
| TMPTA | 16.70 | 16.38 | 16.02 | 14.96 | 14.72 | 0.00 | 0.00 | 15.10 | 15.10 |
| SR-502 | 3.48 | 3.77 | 0.00 | 0.00 | 0.00 | 0.00 | 0.00 | 0.00 | 0.00 |
| SR-349 | 0.00 | 0.00 | 3.86 | 3.59 | 3.93 | 4.00 | 3.62 | 3.62 | 3.62 |
| Vinyl Caprolactam | 0.00 | 0.00 | 0.00 | 1.99 | 0.00 | 0.00 | 0.00 | 0.00 | 0.00 |
| SR-295 | 0.00 | 0.00 | 0.00 | 0.00 | 0.00 | 15.01 | 15.10 | 0.00 | 0.00 |
| SR-399 | 0.00 | 0.00 | 0.00 | 0.00 | 0.00 | 0.00 | 0.00 | 0.00 | 0.00 |
| Irgacure 907 | 1.82 | 1.87 | 1.81 | 1.80 | 2.07 | 2.00 | 2.01 | 2.01 | 2.01 |
| ITX | 0.64 | 0.64 | 0.72 | 0.60 | 0.98 | 0.67 | 0.67 | 0.67 | 0.67 |
| Quantacure EPD | 2.55 | 2.54 | 2.57 | 1.99 | 2.94 | 2.22 | 2.23 | 2.23 | 2.23 |
| Irgacure 819 | 0.46 | 0.46 | 0.45 | 1.00 | 0.50 | 1.11 | 1.12 | 1.12 | 1.12 |
| Irgacure 184 | 2.14 | 1.82 | 2.13 | 0.00 | 1.96 | 0.00 | 0.00 | 0.00 | 0.00 |
| Irgacure 2959 | 0.00 | 0.00 | 0.00 | 1.20 | 0.00 | 1.33 | 1.34 | 1.34 | 1.34 |
| Benzotriazol | 0.40 | 0.37 | 0.44 | 0.30 | 0.39 | 0.33 | 0.33 | 0.33 | 0.33 |
| BYK-356 | 0.46 | 0.47 | 0.45 | 0.40 | 0.70 | 0.44 | 0.40 | 0.40 | 0.40 |
| BHT | 0.18 | 0.19 | 0.23 | 0.10 | 0.11 | 0.11 | 0.02 | 0.02 | 0.02 |
| Victoria pure Blue BO | 0.19 | 0.23 | 0.20 | 0.18 | 0.20 | 0.20 | 0.16 | 0.16 | 0.16 |
| Triphenyl Phosphine | 0.09 | 0.31 | 0.30 | 0.00 | 0.00 | 0.00 | 0.00 | 0.00 | 0.00 |
| Triphenyl Phosphite | 0.03 | 0.22 | 0.20 | 0.00 | 0.00 | 0.00 | 0.00 | 0.00 | 0.00 |
| Irganox 1010 | 0.00 | 0.00 | 0.00 | 0.38 | 0.41 | 0.42 | 0.37 | 0.37 | 0.37 |

The composition of example IX shows excellent results when applied in a very thin film.

### Examples XVIII-XXII

These examples show compositions that fall within the scope of the invention, but illustrate embodiments of the invention that do not have all properties in the most preferred way. These formulations may be less favourable in cure, or in development, or they show less stability during the etching process.

The formulations presented in Table 6 have the same additives and photoinitiators as used in Example I. Difference between Example I and the Examples XVIII to XXII are components A and components B as shown in the Table 6.

TABLE 6

| Components | Composition | MW | Tg | Acid # | Ex. XVIII | Ex. XIX | Ex. XX | Ex. XXI | Ex. XXII |
|---|---|---|---|---|---|---|---|---|---|
| CarbosetGA | St-Ac | 7000 | 120 | 220 | 37.7 | 39.5 | 37 | 36.6 | 8.1 |
| 1160 | | | | | | | | | |
| Elvacite 2669 | MMA/EA/MAA | 60,000 | 70 | 124 | 30.1 | | | | 13.9 |
| CAP-UV-100 | CAP/MA | 18,000 | 120 | 80 | 7.5 | 7.8 | 7.2 | 14.7 | 8.8 |
| Joncryl 690 | St-Ac | 16,500 | 102 | 240 | | 30.3 | 29.1 | 22 | |
| Joncryl 671 | St-Ac | 17,250 | 128 | 212 | | | | | 43.8 |
| SR-368 | | | | | 18.2 | 16.8 | 4.3 | 4.3 | 4.5 |
| TMPTA | | | | | 2.1 | 5.6 | 18.5 | 18.5 | 0 |
| SR-349 | | | | | 4.5 | | 3.9 | 3.9 | 4.4 |
| SR-399 | | | | | | | | | 16.5 |

Ex. XVIII and Ex. XIX show a rather slow cure and also slow development, due to a low amount of liquid compound monomer (TMPTA) in component B.
Ex. XX shows a perfect cure and development, high Tg but has less stability in an etching solution, due to the high amount of polymeric binder, having rather high acid number (240 mg KOH/g), which resulted in a high acid number of powder photoresist (139 mg KOH/g).
Ex. XXI. Increasing the amount of Cellulose Acetate Propionate (CAP-UV-100), which has low acid number did not make an improvement of previous formulation (Ex XX), but made development much slower, because of the higher amount of low acid number component.
Ex. XXII. Use, in component B, of a relatively high amount of a compound (SR-399) having high viscosity slows down the development.

All test results have been summarized in Table 7.

TABLE 7
Influence of Acid Number and presence of high MW binder on photoresist properties

| Example# | I | VIII | IX | X | XI | XII | XIII | XIV | XV | XVI | XVIII | XIX | XX | XXI | XXII |
|---|---|---|---|---|---|---|---|---|---|---|---|---|---|---|---|
| Acid# | 127 | 113 | 113 | 120 | 123 | 123 | 123 | 130 | 134 | 124 | 112 | 151 | 139 | 135 | 123 |
| High MW | 0 | 27 | 27 | 30 | 13 | 13 | 13 | 0 | 13.6 | 12.2 | 27 | 0 | 0 | 0 | 12.7 |
| polymer, % | | | | | | | | | | | | | | | |
| Tg of | 61 | 44 | 44 | 41 | 60 | 64 | 72 | 69 | 64 | 60 | NA | NA | 55 | 55 | 83 |
| powder, | | | | | | | | | | | | | | | |
| DMA | | | | | | | | | | | | | | | |
| Cure | G | G | G | G | G | G | G | G | G | G | S | S | G | G | G |
| Development | G | G | G | G | G | G | G | G | G | G | S | S | G | S | S |
| Etching | G | G | G | G | G | G | G | G | G | G | NA | NA | B | B | G |

G = good
S = slow
B = bad
NA = not analysed

### Examples XXIII-XXV

Fumed silica (Cab-O-Sil TS 530) was added to the composition of example XIV in different amounts. The flowability of the powder after storing the powder for 1, 7 or 14 days at 35° C. was measured. Results of the experiment are listed in table 8.

TABLE 8

| Example | | Ex XIV | Ex XXIII | Ex XXIV | Ex XXV |
|---|---|---|---|---|---|
| wt % Cab-O-Sil TS 530 | | 0 | 0.1 | 0.5 | 1 |
| Temperature | Days | Formulation stability* | | | |
| 35° C. | 0 | 1 | 1 | 1 | 1 |
| 35° C. | 1 | 2 | 2 | 2 | 2 |
| 35° C. | 7 | 2 | 2 | 2 | 2 |
| 35° C. | 14 | 4 | 3 | 2 | 2 |

Description:*
1-free flowing powder
2-big or small chunks, easy crushable by simply shaking the powder
3-stronger chunks, need mixing with tong suppressor
4-particles stronger aggregated then 3, more difficult to separate

1. A radiation curable powder photoresist composition comprising the components
A a polymer
B a reactive compound having unsaturated groups
C a free radical photoinitiator
wherein the powder photoresist composition is soluble in a developer and wherein the powder photoresist composition has a Tg between 40 and 120° C.

2 The radiation curable powder photoresist composition according to claim 1 wherein the polymer has a Tg of at least 70° C.

3 The radiation curable powder photoresist composition according to claim 1, wherein the powder photoresist composition has a Tg between 40 and 120° C.

4 The radiation curable powder photoresist composition according to claim 1, wherein the powder photoresist composition has a ratio of components A and B between 2.5 and 3.3

5. The radiation curable powder photoresist composition according to anyone of claims 1-4, wherein the developer is chosen from the group consisting of a water-alkaline solution or supercritical carbondioxide.

6. A radiation curable powder photoresist composition comprising the components
A a polymer, having a Tg of at least 70° C. and having a functional group that enables the polymer to be soluble in a water alkaline developer solution
B a reactive compound having unsaturated groups
C a free radical photoinitiator
wherein the powder photoresist composition has at least one of the following properties
I an acid value between 90 and 135 mg KOH/g
II a Tg between 40 and 120° C.
III a ratio of components A and B between 2.5 and 3.3

7 The resin composition according to claim 6, wherein the composition shows all three properties I, II and III.

8 The resin composition according to claim 6 or 7, wherein component A comprises a mixture of polymers.

9 The resin composition according to claim 8, wherein the polymers in component A have a number average molecular weight between 1000 and 60000.

10 The resin composition according to claim 8, wherein the polymers in component A have an acid number between 80 and 240 mg KOH/g

11 The resin composition according to claim 6 or 7, wherein the amount of component A is between 55 and 85% by weight.

12 The resin composition according to claim 6 or 7, wherein component B has a melt temperature lower than 50° C.

13 The resin composition according to claim 6 or 7, wherein component B has a melt temperature below the temperature of development by a water alkaline solution of a printed circuit board.

14 The resin composition according to claim 6 or 7, wherein component B comprises one or more compounds having at least 2 unsaturated groups.

15 The resin composition according to claim 6 or 7, wherein component B comprises one or more components having at least 3 unsaturated groups.

16 The resin composition according to claim 6 or 7, wherein one or more of the unsaturated groups comprise acrylate groups.

17 The resin composition according to claim 6 or 7, wherein component B comprises a compound being a liquid at 20° C. and a compound being a solid at 20° C.

18 The resin composition according to claim 17, wherein the solid has a melting temperature higher than 35° C.

19 The resin composition according to claim 18, wherein the liquid component comprises between 12 and 22% by weight, and the solid comprises between 3 and 8% by weight.

20 The resin composition according to claim 6 or 7, wherein component B is present in an amount between 15 and 45 wt % relative to the total composition.

21 A radiation curable powder photoresist composition comprising the components
A a polymer, having a Tg of at least 70° C. and being soluble in supercritical CO₂,
B a reactive compound having unsaturated groups
C a free radical photoinitiator
wherein the powder photoresist composition has at least one of the following properties
I an acid value between 0 and 50 mg KOH/g
II a Tg between 40 and 120° C.
III a ratio of components A and B between 2.5 and 3.3

22 The resin composition according to anyone of claims 1-21, wherein the composition further comprises 0.01-5 wt % of an aerosil.

23 A method of making a resin composition as defined in anyone of the above claims comprising the steps of premixing the components, extruding the components at a temperature between 120 and 170° C. and optionally milling and sieving the extrudate.

24 The method of claim 23, wherein an additional step is applied of coating the extrudate with an aerosil.

25 The method of claim 24, wherein the amount of aerosil is between 0.01 and 5 wt % relative to the total weight of the extrudate.

26 A method of applying a thin layer of a powder to a substrate, wherein a powder composition is applied to a substrate by a process in which the powder particles are first charged by friction or induction in the presence of magnetic or non-magnetic particles, are next transported and are then applied to the substrate or applied to a transfer medium by means of an electric field between the substrate respectively the transfer medium and the means of transport, and subsequently transferred and applied to the substrate, whereafter the powder composition is fused to a continuous layer of resin.

27 The method of claim 26, wherein the powder composition is applied to the substrate by a process in which the powder particles are first charged by friction or induction in the presence of magnetic or non-magnetic particles, are next transported and are then applied to a transfer medium by means of an electric field between the substrate respectively the transfer medium and the means of transport, and subsequently transferred and applied to the substrate, whereafter the powder composition is fused to a continuous layer of resin.

28 A method of making a printed circuit board, comprising the steps of applying a powder photoresist composition to one or both sides of a substrate, selectively exposing the photoresist to radiation, developing the photoresist and etching the substrate, wherein the powder photoresist composition is used as defined in anyone of claims 1-22.

29 The method according to claim 28, wherein the powder photoresist composition is applied to the substrate by means of the method according to claims 26 or 27.

30 Printed circuit boards made in a process wherein a powder composition is used as defined in anyone of claims 1-22.
